(19) United States
(12) Patent Application Publication
(10) Pub. No.: US 2020/0244826 A1
(43) Pub. Date: Jul. 30, 2020

(54) ELECTRIC APPARATUS, RECORDING MEDIUM STORING STATUS MANAGEMENT PROGRAM FOR ELECTRIC APPARATUS, AND METHOD OF MANAGING STATUS

(71) Applicant: Sharp Kabushiki Kaisha, Osaka (JP)

(72) Inventor: KAZUHIKO IDO, Osaka (JP)

(21) Appl. No.: 16/775,231

(22) Filed: Jan. 28, 2020

(30) Foreign Application Priority Data
Jan. 28, 2019 (JP) 2019-012170

(51) Int. Cl. H04N 1/00; H04N 1/32; G06F 3/0482; G06F 3/0488

(52) U.S. Cl. CPC H04N 1/00413; H04N 1/00411; H04N 1/32101; H04N 2201/3273; G06F 3/0482; G06F 3/04883; H04N 2201/0094; H04N 1/00129

(57) ABSTRACT

According to an electric apparatus serving as a multifunction peripheral having a plurality of functions, when an event that affects or might affect at least one of the functions occurs, badges are attached to function selection icons corresponding to the functions that are affected or might be affected. The badges are each displayed in a mode that corresponds to the relationship between the corresponding function and the event.

### BACKGROUND OF THE INVENTION

### Field of the Invention

The present invention relates to an electric apparatus, a non-transitory computer-readable recording medium of a status management program for an electric apparatus, and a method of managing the status, and more particularly to an electric apparatus having a plurality of functions, a non-transitory computer-readable recording medium of a status management program for an electric apparatus for the electric apparatus, and a method of managing the status.

### Description of the Background Art

An example of an electric apparatus having a plurality of functions is a smart phone. That is, a smart phone has a plurality of functions, such as a telephone function, an electronic mail function, and a memo function. Japanese Unexamined Patent Application Publication No. 2013-93020 discloses a technology related to a smart phone, in specific, a technology related to electric equipment (apparatus) having a display provided with a touch panel. According to the technique disclosed in Japanese Unexamined Patent Application Publication No. 2013-93020, a lock screen including an application icon correlated with an application for achieving an appropriate function is displayed on the display provided with a touch panel. If there is new information in the application, an information icon is displayed on the application icon correlated with the application. Hence, when the information icon is displayed on the application icon, the user can intuitively recognize that there is new information in the application correlated with the application icon.

An example of an electric apparatus having a plurality of functions besides a smart phone is a multifunction peripheral (MFP), which is a type of image forming apparatus. In other words, the multifunction peripheral has a plurality of functions, such as a copy function, a facsimile function, and an image scanner function (hereinafter simply referred to as “scanner function”). In such a multifunction peripheral, an event, such as an empty paper tray or a paper jam, may occur that affects or may affect at least one of the functions of the multifunction peripheral. When such an event occurs, it is extremely beneficial to the user to be able to intuitively recognize the occurrence of the event and be informed about which function is affected or likely to be affected by the event.

An object of the present invention is to provide a novel technology regarding an electric apparatus having a plurality of functions and enabling a user to intuitively recognize the occurrence of the event and be informed about which function is affected or likely to be affected by the event.

### SUMMARY OF THE INVENTION

To achieve the object, the present invention includes a first aspect relating to an electric apparatus, a second aspect relating to a status management program of an electric apparatus, and a third aspect relating to a method of managing a status of an electric apparatus.

The first aspect relating to an electric apparatus is premised on that the electric apparatus has a plurality of functions. Under this premise, the first aspect includes a display controller. The display controller displays an operation menu including a plurality of operators on a display screen of a display. The operators correspond respectively to the functions and each receive a selection operation by a user selecting any of the functions. Furthermore, when an event that affects or might affect at least one of the functions occurs, the display controller attaches an indicator indicating the occurrence of the event to the operator corresponding to the at least one function that is affected or might be affected.

It is desirable that the display controller attach the indicator in a mode corresponding to a relationship (relation level) between the function corresponding to the operator to which the indicator is attached and the event represented by the indicator.

It is desirable that, when a plurality of events occur, the display controller attach the indicator to each of the events.

In the first aspect, a first information output device may further be provided. When the event occurs, the first information output device outputs first information regarding the event.

In such a case, the first information output device may output the first information by displaying a first menu including the first information on a display screen of a display.

In the first aspect, an operation receiver and a second information output device may further be provided. The operation receiver is able to receive an information output operation by the user. The second information output device outputs second information regarding an event unresolved when the information output operation is received by the operation receiver.

In such a case, the second information output device may output the second information by displaying a second menu including the second information on a display screen of a display.

When a plurality of events are unresolved when the information output operation is received by the operation receiver, the second information output device displays the second menu including the second information regarding the events.

In the first aspect, a disabling device may further be provided. The disabling device disables the acceptance of selection operations on operators corresponding to functions that are affected by the event.

The display controller may display the operator disabled from receiving the selection operation by the disabling device, the operator being displayed in a mode different from other operators.

In the first aspect, a display may further be provided. In other words, the electric apparatus according to the first aspect may include a display.

An example of the electric apparatus according to the first aspect is a multifunction peripheral.

A status management program for an electric apparatus according to a second aspect of the present invention is premised on that the electric apparatus has a plurality of functions. Under this premise, the second aspect causes a computer of the electric apparatus to execute a display control procedure. In the display controller procedure, an operation menu including a plurality of operators is displayed on a display screen of a display. The operators correspond respectively to the functions and each receive a selection operation by a user selecting any of the functions. Furthermore, in the display control procedure, when an event that affects or might affect at least one of the functions occurs, an indicator indicating the occurrence of the event is attached to the operator corresponding to the at least one function that is affected or might be affected.

A method of managing a status for an electric apparatus according to a third aspect of the present invention is premised on that the electric apparatus has a plurality of functions. Under this premise, the third aspect includes a display control step. In the display control step, an operation menu including a plurality of operators is displayed on a display screen of a display. The operators correspond respectively to the functions and each receive a selection operation by a user selecting any of the functions. Furthermore, in the display control step, when an event that affects or might affect at least one of the functions occurs, an indicator indicating the occurrence of the event is attached to the operator corresponding to the at least one function that is affected or might be affected.

An electric apparatus having a plurality of functions according to the present invention enables a user to intuitively recognize the occurrence of an event that affects or might affect at least one of the functions and be informed about which function is affected or likely to be affected by the event.

### BRIEF DESCRIPTION OF THE DRAWINGS

FIG. 1 is an external perspective view of a multifunction peripheral according to a first embodiment of the present invention;

FIG. 2 is a block diagram illustrating an electrical configuration of the multifunction peripheral according to the first embodiment;

FIG. 3 is a diagram illustrating an example of a display menu of a display according to the first embodiment;

FIG. 4 is a diagram illustrating another example of a display menu of a display according to the first embodiment;

FIG. 5 is a diagram illustrating an example of a display menu of a display according to the first embodiment;

FIG. 6 is a diagram illustrating an example of a display menu of a display according to the first embodiment;

FIG. 7 is a diagram illustrating an example of a display menu of a display according to the first embodiment;

FIG. 8 is a diagram illustrating an example of a display menu of a display according to the first embodiment;

FIG. 9 is a diagram illustrating an example of a display menu of a display according to the first embodiment;

FIG. 10 is a diagram illustrating an example of a display menu of a display according to the first embodiment;

FIG. 11 is a diagram illustrating an example of a display menu of a display according to the first embodiment;

FIG. 12 is a diagram illustrating a list of events according to the first embodiment;

FIG. 13 is a diagram conceptually illustrating the configuration of an event table according to the first embodiment;

FIG. 14 is a diagram conceptually illustrating the configuration of an event table according to the first embodiment;

FIG. 15 is a diagram conceptually illustrating the configuration of a notification management table according to the first embodiment;

FIG. 16 is a memory map conceptually illustrating the configuration in a RAM of a main storage according to the first embodiment;

FIG. 17 is a flowchart illustrating the flow of a status management task according to the first embodiment;

FIG. 18 is a flowchart illustrating the flow of a notification task according to the first embodiment;

FIG. 19 is a flowchart illustrating the flow of a display update task according to the first embodiment;

FIG. 20 is a flowchart illustrating the flow of a home menu display task according to the first embodiment;

FIG. 21 is a flowchart illustrating the flow of a re-notification task according to the first embodiment;

FIG. 22 is a diagram illustrating an example of a display menu of a display according to a second embodiment; and

FIG. 23 is a diagram illustrating an example of a display menu of a display according to a third embodiment.

### DESCRIPTION OF THE PREFERRED EMBODIMENTS

### First Embodiment

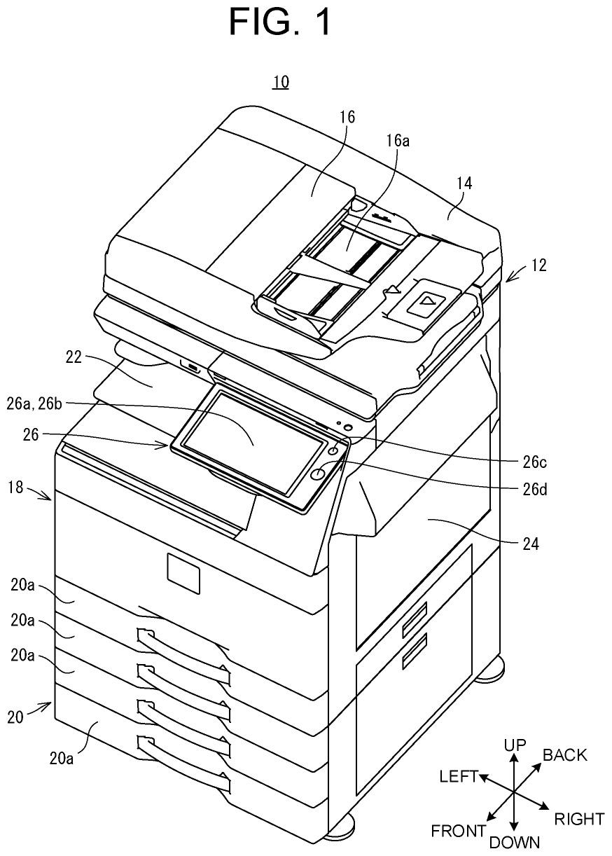

A first embodiment of the present invention will now be described through an exemplary multifunction peripheral 10 illustrated in FIG. 1.

The multifunction peripheral 10 according to the first embodiment is a type of image forming apparatus. The multifunction peripheral 10 has a plurality of functions, such as a copy function, a facsimile function, and a scanner function. FIG. 1 is an external perspective view of the multifunction peripheral 10 and illustrating the front, upper face, and right-side face of the multifunction peripheral 10 installed in a usable state. That is, the vertical direction in FIG. 1 corresponds to the vertical direction of the multifunction peripheral 10. The bottom left in FIG. 1 corresponds to the front of the multifunction peripheral 10 and the top right in FIG. 1 corresponds to the rear of the multifunction peripheral 10. The top left in FIG. 1 corresponds to left of the multifunction peripheral 10 and the bottom right in FIG. 1 corresponds to right of the multifunction peripheral 10

An image reader 12, which is as an example of image reader, is provided in the upper portion (housing) of the multifunction peripheral 10. The image reader 12 performs image reading processing by reading an image of a document (not illustrated) and outputting two-dimensional image data corresponding to the image of the document. Hence, the image reader 12 includes a document table (not illustrated) on which a document is placed. The document table is formed of a transparent material, such as flat glass. In addition, a document holding cover 14 for pressing the document placed on the document table is provided above the document table. The document holding cover 14 is disposed so as to be freely opened and closed via a hinge (not illustrated). An image reading device, a drive mechanism, etc., are disposed below the document table. The image reading device includes a light source, mirrors, lenses, and a line sensor (not illustrated). The drive mechanism moves the image reading device along the bottom surface of the document table.

Furthermore, an automatic document feeder (ADF) 16 is disposed at the upper portion of the document holding cover 14. The automatic document feeder 16 includes a document placing tray 16a on which a plurality of sheet-like documents can be placed in a stacked manner. The automatic document feeder 16 then feeds the documents placed on the document placing tray 16a one by one to the image reading position of the image reader 12. Note that the automatic document feeder 16 is an optional device and may not be provided.

An image former 18 that serves as an image former is provided below the image reader 12. The image former 18 performs an image forming process for forming an image on a sheet-like image recording medium (not illustrated), e.g., paper, fed from the paper feeder 20 one sheet at a time through a known electrophotographic process (Carlson process). The image forming process can applied to both monochrome or polychrome printing. For this reason, the image former 18 includes a photosensitive drum, a charging device, an exposure device, a developing device, a transfer device, a fixing device, etc. (not illustrated), for each of the four components of the CMYK color model. In particular, the developing device includes a toner cartridge (not illustrated). The sheet after the image forming process by the image former 18, that is, the printed sheet is discharged to a center tray 22, which is a main discharge tray.

Note that the paper feeder 20 includes a plurality of, for example, four paper feed cassettes 20a, 20a, . . . Each paper feed cassette 20a, 20a, . . . normally contains sheets having different sizes. Alternatively, some or all of the paper feed cassette 20a, 20a, . . . may contain sheets of the same size. Each paper feed cassette 20a, 20a, . . . is given an individual tray number. For example, the paper feed cassettes 20a, 20a, . . . may be referred to as “tray [1]”, “tray [2]”, . . . in accordance with the tray number. Further, the center tray 22, which is the main discharge tray, is defined by an internal space between the image reader 12 and the image former 18. Alternatively, the main discharge tray may be formed by any other structure. In addition, a side cover 24 is disposed on the right-side face of the multifunction peripheral 10. Although not illustrated, the side cover 24 serves as a manual feed tray that is an auxiliary paper feeder when it is opened. When the side cover 24 is opened, a second cover appears. The second cover is opened to serve as an auxiliary discharge tray or a side tray.

Focusing again on the upper portion of the multifunction peripheral 10, an operating device 26 having a substantially rectangular plate shape is disposed at a front portion of the upper portion of the multifunction peripheral 10, specifically, at a front portion of (the housing of) the image reader 12. The operating device 26 is disposed such one main face is slightly inclined toward the front side of the multifunction peripheral 10. In other words, the one main face is directed obliquely upward. A display 26b provided with a touch panel 26a is disposed on the upper face or one main face of the operating device 26. The upper face of the operating device 26 is further provided with a power-saving button 26c and a home button 26d.

The display 26b provided with the touch panel 26a is an integrated member of the display 26b and the touch panel 26a. The display 26b has a rectangular display screen. The touch panel 26a has a sheet-like touch panel 26a provided so as to overlay the display screen of the display 26b. The touch panel 26a is an example of a touch operation receiver for receiving a touch operation by a user using the multifunction peripheral 10, and is, for example, a capacitive type panel. The display 26b is an example of a display, such as a liquid crystal display (LCD). Various items of information are displayed on the display screen of the display 26b. In particular, various menus, such as the home menu 100 described below, are displayed on the display screen of the display 26b. The touch panel 26a is not limited to a capacitive type. Alternatively, the touch panel 26a may be other types of panels, such an electromagnetic induction type, a resistance film type, or an infrared type. The display 26b is not limited to a liquid crystal display. Alternatively, the display 26b may be an organic electroluminescent (EL) display, or the like.

The power-saving button 26c is, for example, a capacitive switch, and is disposed on the right side of the display 26b provided with the touch panel 26a. The power-saving button 26c is an example of a mode-switching operation receptor for receiving a mode-switching operation by a user to switch the operation mode of the multifunction peripheral 10. In other words, each time the power-saving button 26c is operated (pressed), the operation mode of the multifunction peripheral 10 changes from the normal mode to the power-saving mode or vice versa. Note that the power-saving button 26c is not limited to a capacitive switch and may be a hardware key besides the capacitive switch.

The normal mode refers to a mode in which the multifunction peripheral 10 is in a normal state. In the normal mode, the multifunction peripheral 10 is in a warm-up state. That is, the multifunction peripheral 10 is able to immediately respond to an external command including an operation by the user. When the power-saving button 26c is operated in the normal mode, the operation mode of the multifunction peripheral 10 shifts from the normal mode to the power-saving mode. The power-saving mode refers to a mode in which the multifunction peripheral 10 is in a power-saving state. In the power-saving mode, power supply to some components, such as the image reader 12, the image former 18, and the display 26b provided with the touch panel 26a, is stopped. When the power-saving button 26c is operated in the power-saving mode, the operation mode of the multifunction peripheral 10 shifts from the power-saving mode to the normal mode. As a result, the power supply to each component that has been stopped is re-started, that is, the warm-up is started. Note that, a setting (system setting) may be established to automatically shifted operation mode of the multifunction peripheral 10 from the normal mode to the power-saving mode (automatic power-off), when a state in which no operation state of the multifunction peripheral 10 (the operating device 26) by the user is continued for a predetermined transition period in the normal mode.

The home button 26d is, for example, a capacitive switch, similar to the power-saving button 26c. The home button 26d is disposed on the right side of the display 26b provided with the touch panel 26a, i.e., near the power-saving button 26c. The home button 26d is an example of a home-return operation receiver for receiving a home return operation by a user to display a home menu 100 described below on the display 26b. The home menu 100 will be described below. Note that the home button 26d is also not limited to a capacitive switch and may be a hardware key besides the capacitive switch.

The user usually stands in front of the multifunction peripheral 10 and uses the multifunction peripheral 10 to operate the operating device 26 in particular. In order to improve the operability and visibility of the operating device 26 for the user at that time, the operating device 26 is disposed such that the upper face is slightly inclined toward the front side of the multifunction peripheral 10, as described above. The operating device 26 is disposed so as to be rotatable about a coupling portion with the image reader 12. In this way, inclination angle of the upper face of the operating device 26 can be varied within an appropriate range.

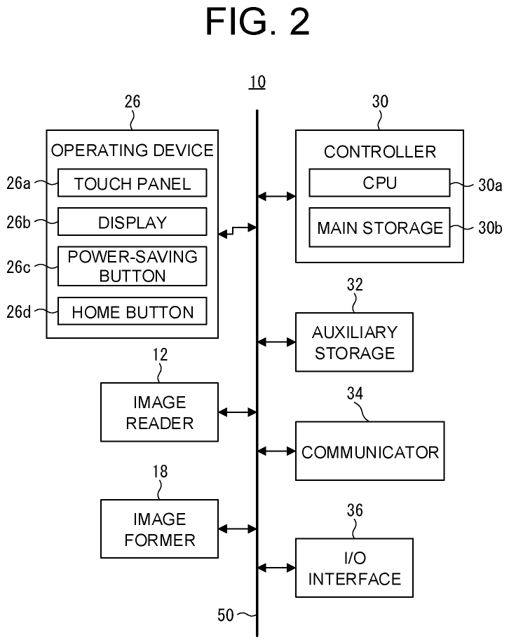

FIG. 2 is a block diagram illustrating the electrical configuration of the multifunction peripheral 10. As illustrated in FIG. 2, the multifunction peripheral 10 further includes a controller 30, an auxiliary storage 32, a communicator 34, and an input/output (I/O) interface 36, besides the image reader 12, the image former 18, and the operating device 26. These components are connected with each other via a common bus 50. The image reader 12, the image former 18, and the operating device 26 are as described above. In FIG. 2, components not directly related to the present invention are not illustrated.

The controller 30 is an example of a controller for comprehensively controlling the multifunction peripheral 10. Hence, the controller 30 includes a computer severing as a control execution unit, for example, a central processing unit (CPU) 30a. The controller 30 further includes a main storage 30b serving as a main storage that is directly accessible by the CPU 30a. Although not illustrated, the main storage 30b includes a read-only memory (ROM) and a random-access memory (RAM). The ROM stores a control program or firmware for controlling the operation of the CPU 30a. The RAM constitutes a work area and a buffer area when the CPU 30a executes processing based on the control program. The main storage 30b includes a rewritable nonvolatile memory (not illustrated). The non-volatile memory stores data might be rewritten, such as an event table 300 described below. When the firmware is updated as described later, the updated firmware is stored in the nonvolatile memory.

The auxiliary storage 32 is an example of auxiliary storage, and includes, for example, a hard disk drive (not illustrated). The auxiliary storage 32 may include another rewritable nonvolatile memory in addition to that in the main storage 30b. Various items of data, such as image data outputted from the image reader 12 and data received through the communicator 34 described below are stored in the auxiliary storage 32, as necessary.

The communicator 34 is an example of a communicator for performing bidirectional communication processing via a network, such as a local area network (LAN) (not illustrated), to which the communicator 34 is connected. Example of a communication partner via the network include appropriate external devices, such as servers (not illustrated), personal computers (PCs), and routers. The communicator 34 is connected to a public telephone line (not illustrated) to also perform bidirectional communication processing via the public telephone line. An example of a communication partner via the public telephone line is a facsimile device (not illustrated).

The input/output interface 36 is an example of an interface for mediating the connection between the controller 30 and various electric components (not illustrated). Examples of such electric components include a paper transport sensor, a paper feed sensor, and a paper discharge sensor. The paper transport sensor detects (the position of) the paper transported in (the housing of) the multifunction peripheral 10. In other words, the paper transport sensor is also a component that detects stagnation of a sheet flowing through the multifunction peripheral 10, i.e., a paper jam. The paper feed sensor detects the presence of paper in each paper feed cassette 20a, that is, whether the paper feed cassette 20a is empty. The paper discharge sensor detects a predetermined height of the pile of printed papers discharged into the center tray 22. In other words, the paper discharge sensor detects when the center tray 22 becomes full.

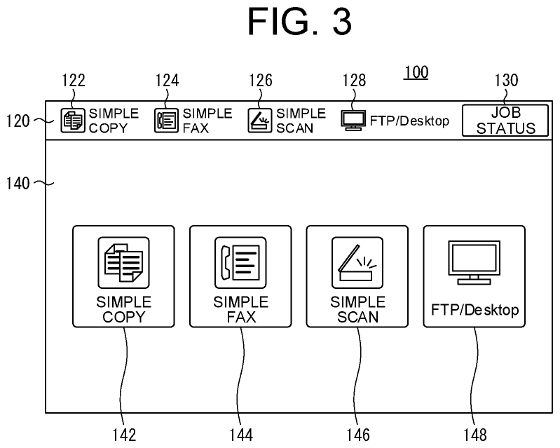

When the multifunction peripheral 10 according to the first embodiment is turned on, the home menu 100, such as the basic menu illustrated in FIG. 3, is displayed on the display 26b. The home menu 100 is one of the operation menus for operating the multifunction peripheral 10, that is, a user interface (UI) menu.

In specific, the home menu 100 includes a strip-shaped display region 120 and a main display region 140. The strip-shaped display region 120 is a horizontally long strip-shaped region that occupies the upper portion of the home menu 100. The strip-shaped display region 120 is provided with a plurality of software keys or function selection mini-icons. For example, four function selection mini-icons 122, 124, 126, and 128 are disposed horizontally in the strip-shaped display region 120. The function selection mini-icon 122 at the left end is a copy function selection mini-icon for selecting the copy function. The second function selection mini-icon 124 from the left is a facsimile function selection mini-icon for selecting a facsimile function. The third function selection mini-icon 126 from the left is a scanner function selection mini-icon for selecting a scanner function. The function selection mini-icon 128 at the right end is a data-transmission scan function selection mini-icon for selecting the data-transmission scan function.

The data-transmission scan function is, that is, one of the extended functions of the scanner function. The data-transmission scan function is a function of transmitting the image data obtained by the scanner function (the image reading processing by the image reader 12) to an appropriate external device via the above-described network. More specifically, the data-transmission scan function includes two functions: a file-server-transmission scan function and a desktop-transmission scan function. The file-server-transmission scan function is a function for transmitting image data obtained by the scanner function to a specific file transfer protocol (FTP) server, which is an external device. The desktop-transmission scan function is a function for transmitting the image data obtained by the scanner function to a specific personal computer, which is an external device.

Another software key or a job-status confirmation button 130 is disposed on, for example, the right side of the horizontally arrayed function selection mini-icons 122, 124, 126, and 128 in the strip-shaped display region 120. The job-status confirmation button 130 is a button for confirming the status of a job being executed, in standby, or has been executed by the multifunction peripheral 10.

The main display region 140 is a region other than the strip-shaped display region 120 in the home menu 100. That is, the main display region 140 is a rectangular region that occupies most of the home menu 100. The main display region 140 is provided with a plurality of software keys or function selection icons. For example, four function selection icons 142, 144, 146, and 148 are disposed horizontally in the main display region 140. The function selection icons 142, 144, 146, and 148 are larger than the function selection mini-icons 122, 124, 126, and 128 in the strip-shaped display region 120. The function selection icons respectively correspond to the functions of function selection mini-icons 122, 124, 126, and 128. That is, the function selection icon 142 on the left end is a copy function selection icon for selecting the copy function. That is, the function selection icon 142 corresponds to the function of the copy function selection mini-icon 122. The second function selection icon 144 from the left is a facsimile function selection icon for selecting the facsimile function. That is, the function selection icon 144 corresponds to the function of the facsimile function selection mini-icon 124. The third function selection icon 146 from the left is a scanner function selection icon for selecting the scanner function. That is, the function selection icon 146 corresponds to the function of the scanner function selection mini-icon 126. The function selection icon 148 on the right end is a data-transmission scan function selection icon for selecting the data-transmission scan function. That is, the function selection icon 148 corresponds to the function of the data-transmission scan function selection mini-icon 128.

Note that the design of the home menu 100 illustrated in FIG. 3 is an example. Various elements, such as software keys and character strings, not illustrated in FIG. 3 are arranged on the actual home menu 100, but here, elements not directly related to the gist of the invention not illustrated. Although detailed explanation including illustration is omitted, the display content of the main display region 140 can be switched in units of pages. For example, when a slide operation to either the left or right direction is performed in the main display region 140, the page of the main display region 140 is switched. Appropriate function selection icons are arranged on the page after this switching. For example, function selection icons for selecting other functions are arranged. The type of the function selection icons arranged on each page can be freely changed by setting.

In the home menu 100 illustrated in FIG. 3, when, for example, the copy function selection mini-icon 122 or the copy function selection icon 142 is operated, an operation menu for the copy function (not illustrated) is displayed in place of the home menu 100. An operation for using the copy function is performed on the operation menu for the copy function. Similarly, when the facsimile function selection mini-icon 124 or the facsimile function selection icon 144 is operated, an operation menu for the facsimile function (not illustrated) is displayed in place of the home menu 100. When the scanner function selection mini-icon 126 or the scanner function selection icon 146 is operated, an operation menu for the scanner function (not illustrated) is displayed in place of the home menu 100. When the data-transmission scan function selection mini-icon 128 or the data-transmission scan function selection icon 148 is operated, an operation menu for the data-transmission scan function (not illustrated) is displayed in place of the home menu 100. Note that the job-status confirmation button 130 is arranged in the same manner on the operation menu for any function. When the job- status confirmation button 130 is operated, a job-status confirmation menu for confirming the job status is displayed.

The multifunction peripheral 10 according to the first embodiment enables a user to intuitively recognize the occurrence of an event that affects or might affect at least one of the functions of the multifunction peripheral 10 and be informed about which function is affected or likely to be affected by the event.

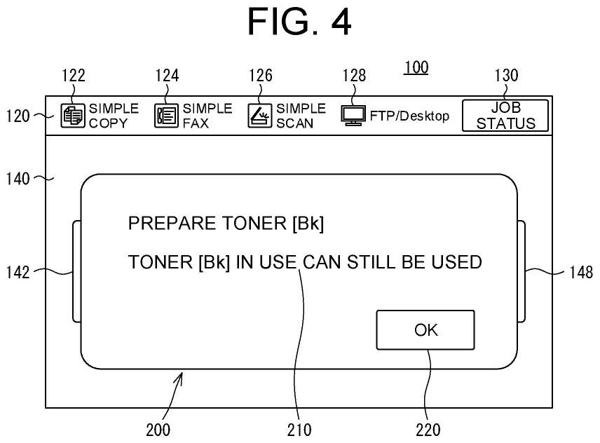

For example, when the level of black (Bk) toner become low, i.e., when a “black-toner level low” event occurs, a dialog box 200 or a message screen, such as that illustrated in FIG. 4 is displayed on the display 26b. The dialog box 200 includes a character string 210 representing an appropriate message corresponding to the event that has occurred, which in this case is the “black-toner level low” event. Therefore, the user is notified by the dialog box 200 including the character string 210 being displayed, and recognizes that an event corresponding to the message represented by the character string 210 has occurred in the multifunction peripheral 10.

Furthermore, the dialog box 200 includes an OK button 220, which is a software key with the character string “OK”. The dialog box 200 including the OK button 220 is a modal dialog. In other words, while the dialog box 200 is being displayed, operations other than the OK button 220 on the display screen of the display 26b (the home menu 100 in FIG. 4) will not receive operations by the user. When the OK button 220 is operated, the dialog box 200 disappears. If the OK button 220 is not operated for a predetermined period after the dialog box 200 is displayed, the dialog box 200 disappears. The predetermined period is several seconds to about one minute, for example, 20 seconds.

The design of the dialog box 200 illustrated in FIG. 4 is a mere example. The design of the dialog box 200, including the size and shape of the dialog box 200, and the arrangement of the character string 210 and the OK button 220, is not limited to the design illustrated in FIG. 4.

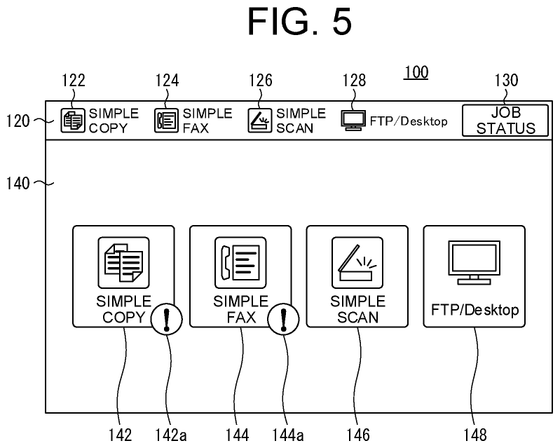

When the dialog box 200 illustrated in FIG. 4 disappears and the home menu 100 is redisplayed, the home menu 100 transitions to that illustrated in FIG. 5. That is, an indicator or badge 142a is attached to the copy function selection icon 142. A similar badge 144a is attached to the facsimile function selection icon 144.

The badge 142a attached to the copy function selection icon 142 has a smaller outer shape than the copy function selection icon 142, and is a circular element provided with an appropriate mark, such as an exclamation mark. The badge 142a is attached to an appropriate portion of the copy function selection icon 142, for example, so as to overlap the lower right corner of the copy function selection icon 142. The badge 142a indicates that an event that might affect the copy function, such as the “black-toner level low” even, described above, is occurring. Therefore, the user can intuitively recognize that some event that might affect the copy function is occurring through the display of the badge 142a.

The badge 144a attached to the facsimile function selection icon 144 is also attached so as to overlap the lower right corner of the facsimile function selection icon 144. The badge 144a indicates that an event that might affect the facsimile function occurred. Such an event is, for example, a black-toner level low, described above. Therefore, the user can intuitively recognize that some event that might affect the facsimile function is occurring through the display of the badge 144a.

In short, the user can intuitively recognize that an event that might affect the copy function and an event that might affect the facsimile function are occurring, through the home menu 100 including the displayed badges illustrated in FIG. 5. In other words, even if the user overlooks the dialog box 200 shown in FIG. 4, the user can recognize that events that might affect the copy function and the facsimile function are occurring through the home menu 100 illustrated in FIG. 5. This is extremely beneficial in various aspects regarding the use and management of the multifunction peripheral 10.

When, for example, the copy function selection icon 142 with the badge 142a on the home menu 100 illustrated in FIG. 5, is operated, the dialog box 200 illustrated in FIG. 4 is redisplayed on the display 26b. This is the same when the copy function selection mini-icon 122 is operated on the home menu 100 illustrated in FIG. 5. Therefore, the user receives a re-notification through the redisplay of the dialog box 200 illustrated in FIG. 4, and thereby can confirm that the “black-toner level low” event is occurring. In other words, the user can confirm that the event represented by the badge 142a illustrated in FIG. 5 is a “black-toner level low” event. When the OK button 220 of the dialog box 200 is operated, or when a certain time elapses after the dialog box 200 has been displayed, the dialog box 200 disappears. Subsequently, the above-described operation screen for the copy function is displayed on the display 26b in place of the home menu 100.

When, for example, the facsimile function selection icon 144 with the badge 144a on the home menu 100 illustrated in FIG. 5, is operated, the dialog box 200 illustrated in FIG. 4 is redisplayed on the display 26b. This is the same when the facsimile function selection mini-icon 124 is operated on the home menu 100 illustrated in FIG. 5. Therefore, the user receives a re-notification through the redisplay of the dialog box 200 illustrated in FIG. 4, and thereby can confirm that the “black-toner level low” event is occurring. In other words, the user can confirm that the event represented by the badge 144a illustrated in FIG. 5 is the “black-toner level low” event. When the OK button 220 of the dialog box 200 is operated, or when a certain time elapses after the dialog box 200 has been displayed, the dialog box 200 disappears. Subsequently, the above-described operation screen for the facsimile function is displayed on the display 26b in place of the home menu 100.

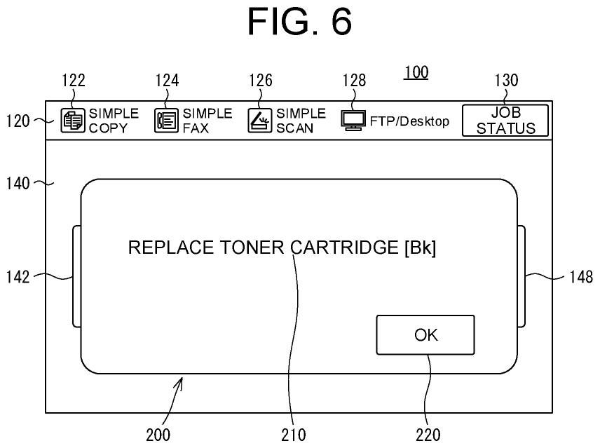

For example, when the black toner runs out, i.e., when a “black toner runout” event occurs, the dialog box 200, such as that illustrated in FIG. 6, is displayed on the display 26b. In other words, notification is made by displaying the dialog box 200. The dialog box 200 also includes a character string 210 that represents an appropriate message corresponding to the event that has occurred, which is a “black toner runout” event, in the same manner as the dialog box 200 illustrated in FIG. 4. The dialog box 200 includes an OK button 220. When the OK button 220 is operated, or when a certain time elapses after the dialog box 200 has been displayed, the dialog box 200 disappears.

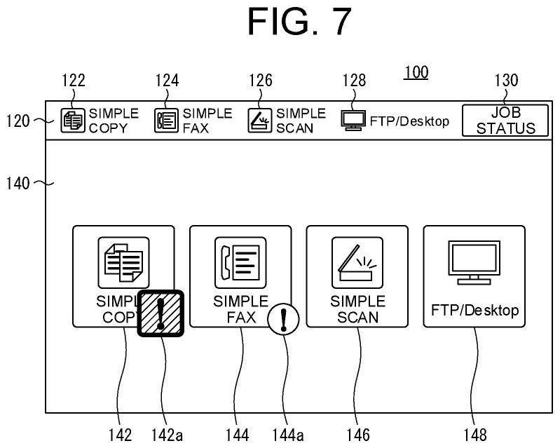

When the home menu 100 is redisplayed, the home menu 100 transitions to that illustrated in FIG. 7. In the home menu 100 illustrated in FIG. 7, the badge 142a is attached to the copy function selection icon 142, as in the home menu 100 illustrated in FIG. 5. The badge 144a is attached to the facsimile function selection icon 144.

Note that the badge 142a attached to the copy function selection icon 142 illustrated in FIG. 7 has a configuration different from that of the badge 142a illustrated in FIG. 5. That is, the badge 142a illustrated in FIG. 7 has a configuration that is more prominent than the badge 142a illustrated in FIG. 5. In specific, the badge 142a illustrated in FIG. 7 and the exclamation mark depicted therein are respectively larger than the badge 142a illustrated in FIG. 5 and the exclamation mark depicted therein. The badge 142a illustrated in FIG. 7 has an appropriate color that is easily noticeable, for example, red. In addition, the badge 142a shown in FIG. 7 has a shape different from that of the badge 142a illustrated in FIG. 5, for example, square. The badge 142a illustrated in FIG. 7 indicates that an event that affects the copy function, such as a “black toner runout” event, i.e., an event that disables the copy function. Therefore, the display of the badge 142a allows the user to intuitively recognize that an event affecting the copy function is occurring, that is, the copy function is being disabled.

The badge 144a attached to the facsimile function selection icon 144 illustrated in FIG. 7 has the same configuration as that of the badge 144a illustrated in FIG. 5. That is, the badge 144a illustrated in FIG. 7 indicates that an event that might affect the facsimile function, such as a “black toner runout” event, is occurring. Therefore, the display of the badge 144a allows the user to intuitively recognize that an event affecting the facsimile function is occurring.

The “black toner runout” event affects the facsimile reception function (in specific, the printing of the data received through the facsimile reception function) of the facsimile function, but does not affect the facsimile transmission function of the facsimile function. Therefore, the badge 144a attached to the facsimile function selection icon 144 when the “black toner runout” event occurs has the configuration illustrated in FIG. 7. That is, the badge 144a indicates that an event that might affect the facsimile function is occurring.

In this way, the user can intuitively recognize that an event that affects the copy function and an event that might affect the facsimile function are occurring through the home menu 100 including the displayed badges, as illustrated in FIG. 7.

When, for example, the copy function selection icon 142 with the badge 142a on the home menu 100 illustrated in FIG. 7, is operated, the dialog box 200 illustrated in FIG. 6 is redisplayed on the display 26b. This is the same when the copy function selection mini-icon 122 is operated on the home menu 100 illustrated in FIG. 7. Therefore, the user receives a re-notification through the redisplay of the dialog box 200 illustrated in FIG. 6, and thereby can confirm that the “black toner runout” event is occurring. In other words, the user can confirm that the event represented by the badge 142a illustrated in FIG. 7 is the “black toner runout” event. When the OK button 220 of the dialog box 200 is operated, or when a certain time elapses after the dialog box 200 has been displayed, the dialog box 200 disappears. Subsequently, the above-described operation screen for the copy function is displayed on the display 26b in place of the home menu 100. Even if the operation menu for the copy function is displayed, the copy function cannot be used.

When, for example, the facsimile function selection icon 144 with the badge 144a on the home menu 100 illustrated in FIG. 7, is operated, the dialog box 200 illustrated in FIG. 6 is redisplayed on the display 26b. This is the same when the facsimile function selection mini-icon 124 is operated on the home menu 100 illustrated in FIG. 7. Therefore, the user receives a re-notification through the redisplay of the dialog box 200 illustrated in FIG. 6, and thereby can confirm that the “black toner runout” event is occurring. In other words, the user can confirm that the event represented by the badge 144a illustrated in FIG. 7 is the “black toner runout” event. When the OK button 220 of the dialog box 200 is operated, or when a certain time elapses after the dialog box 200 has been displayed, the dialog box 200 disappears. Subsequently, the above-described operation screen for the facsimile function is displayed on the display 26b in place of the home menu 100. Note that even if the operation menu for the facsimile function is displayed, only the facsimile transmission function can be used. In other words, the facsimile function can be used with restrictions.

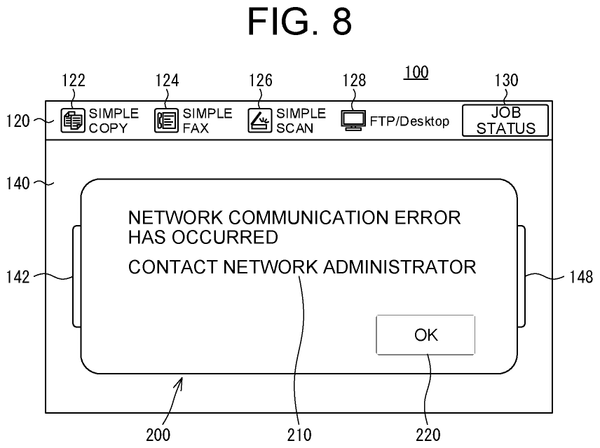

For example, when a “NETWORK COMMUNICATION ERROR” event in which communication via the above-described network is disabled, a dialog box 200, such as that illustrated in FIG. 8, is displayed on the display 26b. In other words, notification is made by displaying the dialog box 200. The dialog box 200 includes a character string 210 representing an appropriate message corresponding to the event that has occurred, which in this case is the “NETWORK COMMUNICATION ERROR” event. The dialog box 200 includes an OK button 220. When the OK button 220 is operated, or when a certain time elapses after the dialog box 200 has been displayed, the dialog box 200 disappears.

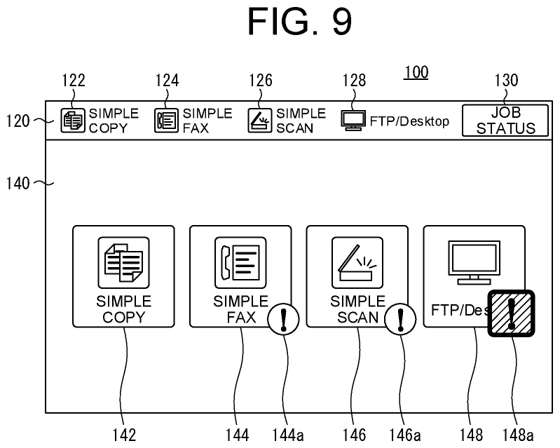

When the home menu 100 is redisplayed, the home menu 100 transitions to that illustrated in FIG. 9. In the home menu 100 illustrated in FIG. 9, a badge 144a is attached to the facsimile function selection icon 144. A badge 146a is attached to the scanner function selection icon 146. A badge 148a is attached to the data-transmission scan function selection icon 148.

The badge 144a attached to the facsimile function selection icon 144 has the same configuration as that of the badges 144a illustrated in FIGS. 5 and 7. That is, the badge 144a illustrated in FIG. 9 indicates that an event that might affect the facsimile function, such as the “NETWORK COMMUNICATION ERROR” event, is occurring. Therefore, the display of the badge 144a allows the user to intuitively recognize that an event affecting the facsimile function is occurring.

The “NETWORK COMMUNICATION ERROR” event affects facsimile communication via a network (Internet facsimile communication) of the facsimile function, but does not affect facsimile communication via a public telephone line, such as that described above. Therefore, the badge 144a attached to the facsimile function selection icon 144 when the “NETWORK COMMUNICATION ERROR” event occurs has the configuration illustrated in FIG. 9. That is, the badge 144a indicates that an event that might affect the facsimile function is occurring.

The badge 146a attached to the scanner function selection icon 146 illustrated in FIG. 9 has the same configuration as that of the badge 144a attached to the facsimile function selection icon 144. That is, the badge 146a illustrated in FIG. 9 indicates that an event that might affect the scanner function, such as the “NETWORK COMMUNICATION ERROR” event, is occurring. Therefore, the display of the badge 146a allows the user to intuitively recognize that an event affecting the scanner function is occurring.

The scanner function has a basic function or a main-body saving function that saves (stores) the image data obtained by the scanner function (image reading processing by the image reader 12) in the auxiliary storage 32. The scanner function has extended functions, such as the data-transmission scan function (the file server transmission scan function and the desktop transmission scan function) as well as an electronic-mail (e-mail) transmission scan function, shared-folder transmission scan function. The e-mail transmission scan function is a function for attaching the image data obtained by the scanner function to an electronic mail and transmitting the e-mail. The e-mail transmission scan function is able to store image data obtained by the scan function in a predetermined storage location, such as the auxiliary storage 32, and transmits information regarding the storage location of the image data (for example, an internet protocol (IP) address) by e-mail. The shared-folder transmission scanner function is a function for transmitting the image data obtained by the scanner function to a pre-created shared folder. The shared-folder can be created in the auxiliary storage 32 or can be created in an external device, such as a personal computer or a server.

The main-body saving function of such a scanner function is not particularly affected even when a network communication error occurs. Also, the shared-folder transmission scan function is not affected by a network communication error if a shared folder is created in the auxiliary storage 32. On the other hand, the data-transmission scan function and the e-mail transmission scan function become inoperable when a network communication error occurs. In other words, the data-transmission scan function and the e-mail transmission scan function are affected by a network communication error. If a shared folder is creased on an external device, the shared-folder transmission scan function also becomes inoperable during a network communication error. In other words, the shared-folder transmission scan function is affected by a network communication error. That is, the “NETWORK COMMUNICATION ERROR” event does not affect all scanner functions, but does affect some of the scanner functions. Therefore, the badge 146a attached to the scanner function selection icon 146 when the “NETWORK COMMUNICATION ERROR” event occurs has the configuration illustrated in FIG. 9. That is, the badge 146a indicates that an event that might affect the scanner function is occurring.

Furthermore, the badge 148a attached to the data-transmission scan function selection icon 148 illustrated in FIG. 9 has a configuration different from that of the badges 144a and 146a illustrated in FIG. 9. That is, the badge 148a illustrated in FIG. 9 has a configuration that is similar to, for example, that of the badge 142a attached to the copy function selection icon 142 illustrated in FIG. 7. The badge 148a illustrated in FIG. 9 indicates that an event that affects the data-transmission scan function, such as a “NETWORK COMMUNICATION ERROR” event, i.e., an event that disables the data-transmission scan function. Therefore, the display of the badge 148a allows the user to intuitively recognize that an event affecting the data-transmission scan function is occurring, that is, the data-transmission scan function is being disabled.

In short, the user can intuitively recognize that an event that might affect the facsimile function and an event that might affect the scanner function are occurring, through the home menu 100 including the displayed badges illustrated in FIG. 9. The user can intuitively recognize that an event that affects the data-transmission scan function is occurring.

When, for example, the facsimile function selection icon 144 with the badge 144a on the home menu 100 illustrated in FIG. 9, is operated, the dialog box 200 illustrated in FIG. 8 is redisplayed on the display 26b. This is the same when the facsimile function selection mini-icon 124 is operated on the home menu 100 illustrated in FIG. 9. Therefore, the user receives a re-notification through the redisplay of the dialog box 200 illustrated in FIG. 8, and thereby can confirm that the “NETWORK COMMUNICATION ERROR” event is occurring. In other words, the user can confirm that the event represented by the badge 144a illustrated in FIG. 9 is the “NETWORK COMMUNICATION ERROR” event. When the OK button 220 of the dialog box 200 is operated, or when a certain time elapses after the dialog box 200 has been displayed, the dialog box 200 disappears. Subsequently, the above-described operation screen for the facsimile function is displayed on the display 26b in place of the home menu 100. Note that even if the operation menu for the facsimile function is displayed, only the facsimile communication via a public phone line can be used. In other words, the facsimile function can be used with restrictions.

When, for example, the scanner function selection icon 146 with the badge 146a on the home menu 100 illustrated in FIG. 9, is operated, the dialog box 200 illustrated in FIG. 8 is redisplayed on the display 26b. This is the same when the scanner function selection mini-icon 126 is operated on the home menu 100 illustrated in FIG. 9. Therefore, the user receives a re-notification through the redisplay of the dialog box 200 illustrated in FIG. 8, and thereby can confirm that the “NETWORK COMMUNICATION ERROR” event is occurring. In other words, the user can confirm that the event represented by the badge 146a illustrated in FIG. 9 is the “NETWORK COMMUNICATION ERROR” event. When the OK button 220 of the dialog box 200 is operated, or when a certain time elapses after the dialog box 200 has been displayed, the dialog box 200 disappears. Subsequently, the above-described operation screen for the scanner function is displayed on the display 26b in place of the home menu 100. Note that even if the operation menu for the scanner function is displayed, only some of the functions including the main-body saving function can be used. In other words, the scanner function can be used with restrictions.

When, for example, the data-transmission scan function selection icon 148 with the badge 148a on the home menu 100 illustrated in FIG. 9, is operated, the dialog box 200 illustrated in FIG. 8 is redisplayed on the display 26b. This is the same when the data-transmission scan function selection mini-icon 128 is operated on the home menu 100 illustrated in FIG. 9. Therefore, the user receives a re-notification through the redisplay of the dialog box 200 illustrated in FIG. 8, and thereby can confirm that the “NETWORK COMMUNICATION ERROR” event is occurring. In other words, the user can confirm that the event represented by the badge 148a illustrated in FIG. 9 is the “NETWORK COMMUNICATION ERROR” event. When the OK button 220 of the dialog box 200 is operated, or when a certain time elapses after the dialog box 200 has been displayed, the dialog box 200 disappears. Subsequently, the above-described operation screen for the data-transmission scan function is displayed on the display 26b in place of the home menu 100. Note that, even if the operation menu for the data-transmission scan function is displayed, the data transmission scan function cannot be used.

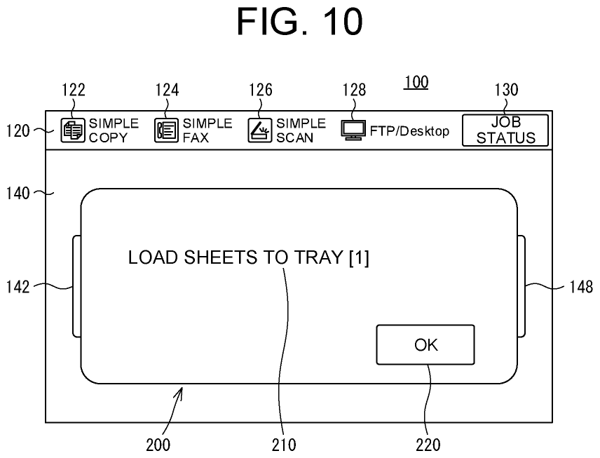

In addition to this, if an event in which the sheets in the paper feed cassette 20a of a tray [1] have run out, i.e., an “tray [1] empty” event, for example, after the above-described “black-toner level low” event has already occurred, the dialog box 200 illustrated in FIG. 10 is displayed on the display 26b. In other words, notification is made by displaying the dialog box 200. The dialog box 200 includes a character string 210 representing an appropriate message corresponding to the event that has occurred, which in this case is the “tray [1] empty” event. The dialog box 200 includes an OK button 220. When the OK button 220 is operated, or when a certain time elapses after the dialog box 200 has been displayed, the dialog box 200 disappears.

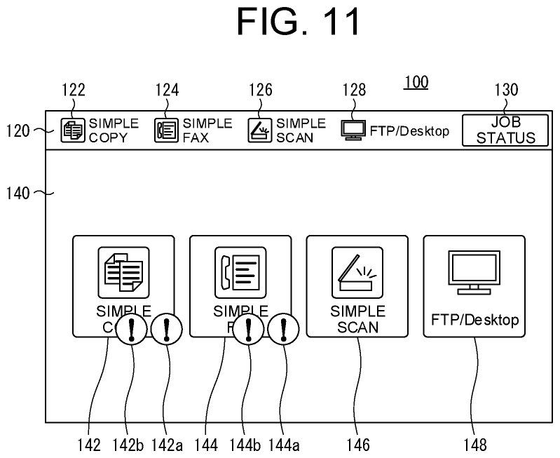

When the home menu 100 is redisplayed, the home menu 100 transitions to that illustrated in FIG. 11. In the home menu 100 illustrated in FIG. 11, two badges 142a and 142b are attached to the copy function selection icon 142. Also, two badges 144a and 144b are attached to the facsimile function selection icon 144.

One of the two badges 142a and 142b attached to the copy function selection icon 142, for example, the badge 142a indicates that the “black-toner level low” event is occurring. The other badge 142b indicates that the “tray [1] empty” event is occurring. More precisely, the badge 142a indicates that the event having higher priority among the “black-toner level low” event and the “tray [1] empty” event, i.e., the “black-toner level low” event is occurring. The badge 142b indicates that the event having a lower priority among the two events, i.e., the “tray [1] empty” event is occurring. The badge 142a, which indicates that one of the two events having the higher priority is occurring, is attached to the copy function selection icon 142 so as to overlap with the lower right corner of the copy function selection icon 142. The badge 142b, which indicates that one of the two events having the lower priority is occurring, is disposed on the left side of the badge 142a, so as to overlap with the lower edge of the copy function selection icon 142. Therefore, the user can be notified by the two badges 142a and 142b attached to the copy function selection icon 142 and intuitively recognize that two events that might affect the copy function are occurring.

Even if the “tray [1] empty” event occurs, the copy function can be used by specifying another tray (paper feed cassette 20a) as the paper source. Therefore, the badge 142b attached to the copy function selection icon 142 when the “tray [1] empty” event occurs has the configuration illustrated in FIG. 11. That is, the badge 142b indicates that an event that might affect the copy function is occurring. Note that the badge 142a indicating that the “black-toner level low” event is occurring, that is, the badge 142a indicating that a “black-toner level low” event that might affect the copy function is occurring has the configuration illustrated in FIG. 11, which is similar to that of the badge 142a illustrated in FIG. 5.

One of the two badges 144a and 144b attached to the facsimile function selection icon 144 illustrated in FIG. 11, for example, the badge 144a also indicates that the “black-toner level low” event is occurring. The badge 144a is disposed so as to overlap the lower right corner of the facsimile function selection icon 144. The other badge 144a indicates that the “tray [1] empty” event is occurring. The badge 144b is disposed on the left side of the badge 144a so as to overlap the lower edge of the facsimile function selection icon 144. Therefore, the user can be notified by the two badges 144a and 144b attached to the facsimile function selection icon 144 and intuitively recognize that two events that might affect the facsimile function are occurring.

The “tray [1] empty” event affects the facsimile reception function (precisely, the printing of the data received through the facsimile reception function) of the facsimile function, but does not affect the facsimile transmission function of the facsimile function. Therefore, the badge 144b attached to the facsimile function selection icon 144 when the “tray [1] empty” event occurs has the configuration illustrated in FIG. 11. That is, the badge 144b indicates that an event that might affect the facsimile function is occurring. Note that the badge 144a indicating that the “black-toner level low” event is occurring, that is, the badge 144a indicating that a “black-toner level low” event that might affect the facsimile function is occurring has the configuration illustrated in FIG. 11, which is similar to that of the badge 144a illustrated in FIG. 5.

When a plurality of events are occurring, a badge is displayed for each event. Therefore, the user can intuitively recognize that two events that might affect the copy function and two events that might affect the facsimile function are occurring, through the home menu 100 including the displayed badges illustrated in FIG. 11.

When, for example, the copy function selection icon 142 with the two badges 142a and 142b on the home menu 100 illustrated in FIG. 11, is operated, the dialog box 200 illustrated in FIG. 4 is redisplayed on the display 26b. Specifically, the dialog box 200 corresponding to the event having the higher priority among the two events indicated by the two badges 142a and 142b, i.e., the “black-toner level low” event, is displayed on the display 26b. This is the same when the copy function selection mini-icon 122 is operated on the home menu 100 illustrated in FIG. 11. Therefore, the user receives a re-notification through the redisplay of the dialog box 200 illustrated in FIG. 4, and thereby can confirm that the “black-toner level low” event is occurring. In other words, the user can confirm that the event represented by one of the two badges 142a and 142b is the “black-toner level low” event. When the OK button 220 of the dialog box 200 is operated, or when a certain time elapses after the dialog box 200 has been displayed, the dialog box 200 disappears.

When the dialog box 200 illustrated in FIG. 4 disappears in this way, then the dialog box 200 illustrated in FIG. 10 is displayed on the display 26b. That is, the dialog box 200 corresponding to the event having the lower priority described above among the two events indicated by the two badges 142a and 142b, as described above, i.e., the “tray [1] empty” event, is displayed on the display 26b. Therefore, the user receives a re-notification through the redisplay of the dialog box 200 illustrated in FIG. 10, and thereby can confirm that the “tray [1] empty” event is occurring. In other words, the user can confirm that the event represented by the other one of the two badges 142a and 142b described above is the “tray [1] empty” event. When the OK button 220 of the dialog box 200 is operated, or when a certain time elapses after the dialog box 200 has been displayed, the dialog box 200 disappears. Subsequently, the above-described operation screen for the copy function is displayed on the display 26b in place of the home menu 100.

When, for example, the facsimile function selection icon 144 with the two badges 144a and 144b on the home menu 100 illustrated in FIG. 11, is operated, the dialog box 200 illustrated in FIG. 4 is redisplayed on the display 26b. That is, the dialog box 200 corresponding to the event having the highest priority among the two events indicated by the two badges 144a and 144b, i.e., the “black-toner level low” event, is displayed on the display 26b. This is the same when the facsimile function selection mini-icon 124 is operated on the home menu 100 illustrated in FIG. 11. Therefore, the user receives a re-notification through the redisplay of the dialog box 200 illustrated in FIG. 4, and thereby can confirm that the “black-toner level low” event is occurring. In other words, the user can confirm that the event represented by one of the two badges 144a and 144b described above is the “black-toner level low” event. When the OK button 220 of the dialog box 200 is operated, or when a certain time elapses after the dialog box 200 has been displayed, the dialog box 200 disappears.

When the dialog box 200 illustrated in FIG. 4 disappears in this way, then the dialog box 200 illustrated in FIG. 10 is displayed on the display 26b. That is, the dialog box 200 corresponding to the event having the higher priority among the two events indicated by the two badges 144a and 144b described above, i.e., the “tray [1] empty” event, is displayed on the display 26b. Therefore, the user receives a re-notification through the redisplay of the dialog box 200 illustrated in FIG. 10, and thereby can confirm that the “tray [1] empty” event is occurring. In other words, the user can confirm that the event represented by the other one of the two badges 144a and 144b described above is the “tray [1] empty” event. When the OK button 220 of the dialog box 200 is operated, or when a certain time elapses after the dialog box 200 has been displayed, the dialog box 200 disappears. Subsequently, the above-described operation screen for the facsimile function is displayed on the display 26b in place of the home menu 100.

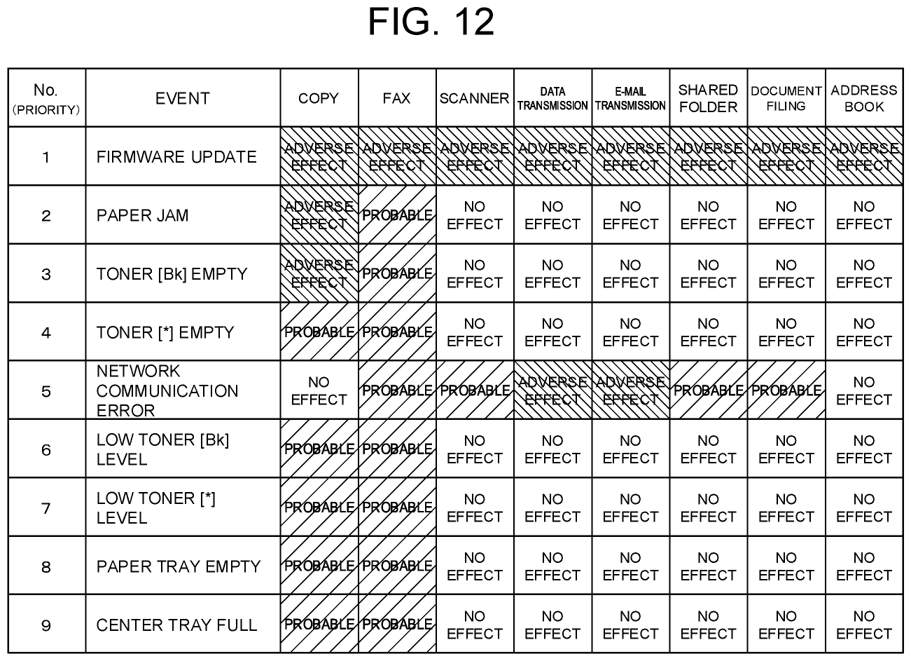

FIG. 12 illustrates a list of events that affects or might affect at least one of the functions of the multifunction peripheral 10. The list includes nine assumed events. In specific, a “ FIRMWARE UPDATE ” event is also assumed in addition to the “black toner empty (TONER [BK] EMPTY)” event, the “ NETWORK COMMUNICATION ERROR ” event, the “black-toner level low (LOW TONER [BK] LEVEL)” event, and the “tray [#] empty (wherein # is any number between 1 to 4)” event including the “tray [1] empty” event described above. Other assumed events are a “ PAPER JAM ” event, a “color toner empty (TONER [*] EMPTY (where * is any one of C, Y, and M))” event, a “color-toner level low (LOW TONER [*] LEVEL (where * is any one of C, Y, and M))” and a “ CENTER TRAY FULL”. Note that the “ FIRMWARE UPDATE ” event described above is an event in which the firmware is updated. The “ CENTER TRAY FULL ” event is an event in which the center tray 22 becomes full.

Each event is given an individual event number (No.). The event number is also an index indicating the priority of the corresponding event. For example, an event with a smaller event number has a higher priority, and a larger event number has a lower priority. The priority is determined as appropriate in accordance with the nature of the event (severity, solvability, etc.).

The relationships between the events and the functions of the multifunction peripheral 10 are specified. Examples of the functions of the multifunction peripheral 10 include a document filing function and an address book function in addition to the copy function, the facsimile function, the scanner function, the data-transmission scan function, the electronic-mail transmission scan function, and the shared-folder scan function described above. Note that the document filing function saves image data obtained through the scanner function and data received through the facsimile function, to the auxiliary storage 32 or an external storage device (not illustrated), such as a universal serial bus (USB) memory. The address book function is a function for managing destination information, such as the facsimile numbers used in the facsimile function and e-mail address used in the electronic-mail transmission scan function.

For example, the “FIRMWARE UPDATE” event affects all functions of the multifunction peripheral 10, that is, the “FIRMWARE UPDATE” event establishes such a relationship with each of the functions. The “PAPER JAM” event affects the copy function, might affect the facsimile function, and does not affect the other functions. Similarly, the “black toner empty” event affects the copy function, might affect the facsimile function, and does not affect the other functions. The “color toner empty” might event affect the copy function and the facsimile function, and does not affect the other functions. The “NETWORK COMMUNICATION ERROR” event affects the data-transmission scan function and the electronic-mail transmission scan function, might affect the facsimile function, the scanner function, the shared-folder function, and the document filing function, and does not affect the other functions. The “black-toner level low” event might affect the copy function and the facsimile function, and does not affect the other functions. Similarly, the “color-toner level low” event might affect the copy function and the facsimile function, and does not affect the other functions. The “tray [#] empty” event might also affect the copy function and the facsimile function, and does not affect the other functions. The “CENTER TRAY FULL” event might also affect the copy function and the facsimile function, and does not affect the other functions.

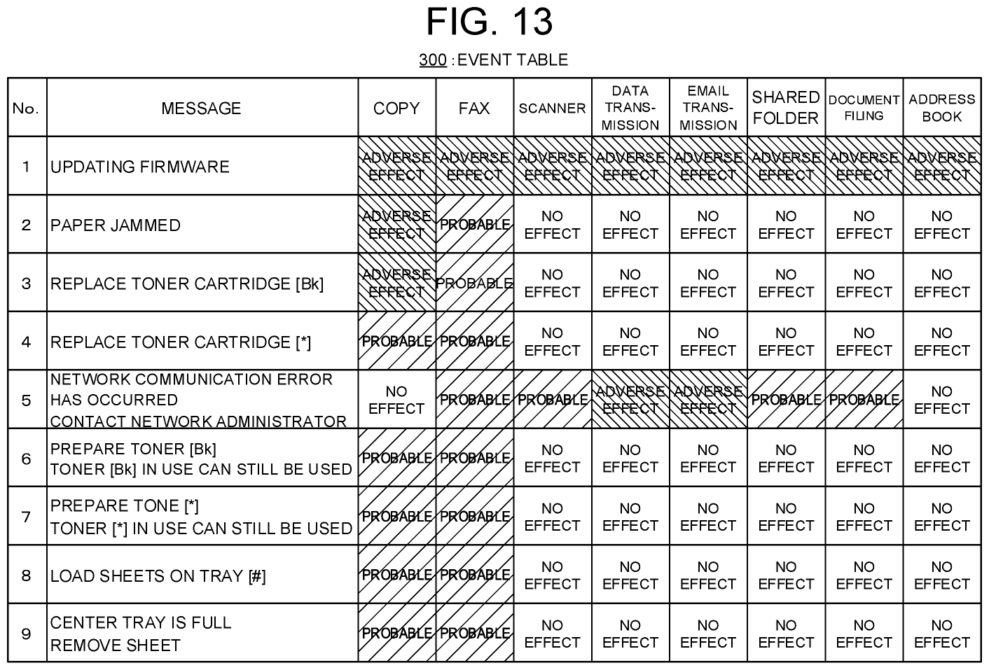

According to the first embodiment, the notification, the badge display, and the re-notification are performed as described above. To achieve the notification, etc., an event table 300, such as that illustrated FIG. 13, is provided. The event table 300 is created based on the list illustrated in FIG. 12. The event table 300 stores, for each event, data indicating the event number, text data or the original data of the character string 210 in the dialog box 200, and data indicating the relationship between each function of the multifunction peripheral 10 and the corresponding event. Note that the event table 300 is stored in the rewritable nonvolatile memory of the main storage 30b described above. In FIG. 13, the hatched pattern indicates a relationship in which the event causes an adverse effect or might cause an adverse effect. The hatched pattern is provided in the same manner as in FIG. 12, to enhance the visibility of FIG. 13. The actual event table 300 does not store such a hatched pattern or data on such hatched pattern.

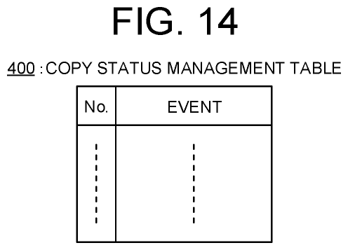

A status management table 400 illustrated in FIG. 14 is provided. The status management table 400 stores data representing events currently occurring in the multifunction peripheral 10, i.e., unresolved events. More specifically, the status management table 400 stores data representing the event numbers of the events. The data representing the event numbers stored in the status management table 400 are given management numbers (No.) in the order of occurrence. The status management table 400 is also stored in a rewritable nonvolatile memory in the main storage 30b.

Furthermore, a temporary storage table is provided into which the content stored in the status management table 400 are directly copied at a predetermined timing, although not illustrated in the drawings. The timing of the copying of the content of the status management table 400 into the temporary storage table will be described in detail below. The temporary storage table is also stored in a rewritable nonvolatile memory in the main storage 30b.

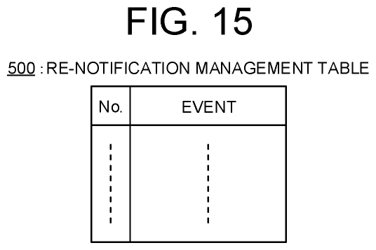

In addition to this, a re-notification management table 500 illustrated in FIG. 15 is provided. The re-notification management table 500 is used at the time of the above-mentioned re-notification, and is used at the time of executing the re-notification task described below in detail. The usage procedure of the re-notification management table 500 will be described below in detail. The re-notification management table 500 stores data representing event numbers of events that are to be re-notified among the events currently occurring. Appropriate management numbers (No.) are given to the data representing event numbers. The re-notification management table 500 is also stored in a rewritable nonvolatile memory in the main storage 30b.

The occurrence of each event is determined by the CPU 30a. In detail, the occurrence of each event is determined in the following manner. For example, firmware update is determined by the user performing a predetermined firmware update operation. A paper jam is determined on basis of a detected result of the paper transport sensor described above. Runout of black toner, runout of color toner, a low black-toner level, and a low color toner level are determined through communication with the image former 18. A network communication error is determined through communication with the communicator 34. Empty paper feed cassettes 20a are determined on the basis of a detected result by the above-mentioned paper feed sensor. A full center tray is determined on the basis of a detected result by the paper discharge sensor described above.

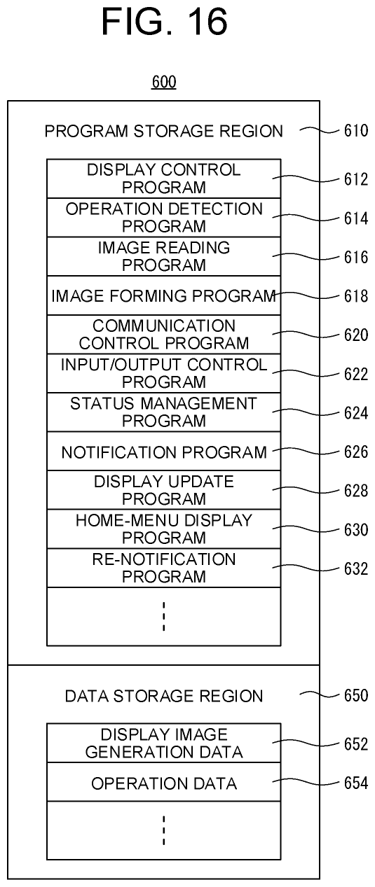

FIG. 16 illustrates a memory map 600 that conceptually represents the configuration of the RAM of the main storage 30b.

As illustrated in the memory map 600, the RAM of the main storage 30b has a program storage region 610 and a data storage region 650. The program storage region 610 stores the above-described control program. The control program includes a display control program 612, an operation detection program 614, an image reading program 616, an image forming program 618, a communication control program 620 and an input/output control program 622. The control program further includes a status management program 624, a notification program 626, a display update program 628, a home-menu display program 630, a re-notification program 632.

The display control program 612 is a program for generating display menu data necessary to display, on the display 26b, various menus, such as the home menu 100 and the dialog box 200. The operation detection program 614 is a program for detecting the operated state of the operating device 26, particularly, the touch panel 26a. The image reading program 616 is a program for controlling the image reader 12. The image forming program 618 is a program for controlling the image former 18. The communication control program 620 is a program for controlling the communicator 34. The input/output control program 622 is a program for transmitting and receiving signals to/from various electric components, such as the paper transport sensor, the paper feed sensor, and the paper discharge sensor described above, via the input/output interface 36.

The status management program 624 is a program for causing the CPU 30a to execute the status management task described below. The notification program 626 is a program for causing the CPU 30a to execute the notification task described below. The display update program 628 is a program for causing the CPU 30a to execute the display update task described below. The home-menu display program 630 is a program for causing the CPU 30a to execute the home-menu display task described below. The re-notification program 632 is a program for causing the CPU 30a to execute the re-notification task described below.

The data storage area 650 stores various items of data. Such various items of data include display image generation data 652 and operation data 654.

The display image generation data 652 is data such as polygon data and text data used in the generation of display menu data based on the display control program 612 described above. The operation data 654 is data representing the operated state of the touch panel 26a. Specifically, the operation data 654 is time-series data representing the position (coordinates) of the touch panel 26a touched by the user.

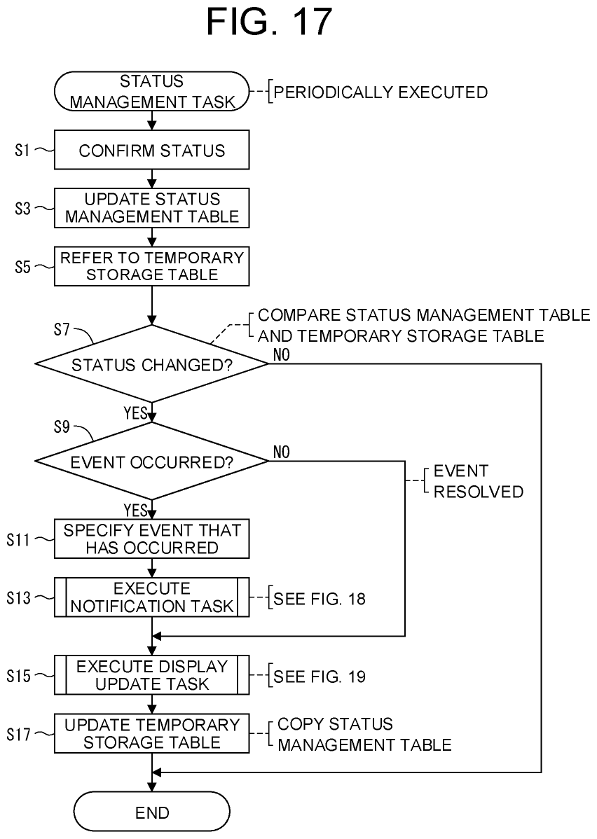

The CPU 30a executes the status management task in accordance with the status management program 624. FIG. 17 illustrates the process of the status management task. Note that the status management task is periodically executed when the operation mode of the multifunction peripheral 10 is in the normal mode, and is repeatedly executed at relatively short time intervals (cycles) of, for example, several seconds to several minutes. When the status management task is executed for the first time, for example, immediately after the multifunction peripheral 10 is turned on, the temporary storage table described above is initialized, that is, the content of the temporary storage table is deleted.

In the status management task, the CPU 30a first confirms the status of the multifunction peripheral 10 in step S1. In specific, the CPU 30a confirms whether at least one of the functions of the multifunction peripheral 10 is affected or might be affected. The CPU 30a then advances process to step S3.

In step S3, the CPU 30a updates the status management table 400 on the basis of the confirmed result in step S1. In specific, if an event that affect or might affect at least one of the functions of the multifunction peripheral 10 is occurring, the CPU 30a stores data representing the event, specifically, data representing the event number of the event in the status management table 400. The CPU 30a then advances the process to step S5.

In step S5, CPU 30a refers to the temporary storage table described above. When step S5 is executed for the first time, that is, when the status management task including step S5 is executed for the first time, the temporary storage table is in an initialized state as described above, that is, no data is stored therein. The CPU 30a then advances the process to step S7.

In step S7, the CPU 30a compares the content stored in the status management table 400 and the content stored in the temporary storage table, and determines whether the status of the multifunction peripheral 10 has changed, i.e., whether the occurrence states of the event described above has changed. For example, if the occurrence state of the event has not changed (S7: NO), the CPU 30a ends the status management task. If the occurrence state of the event has changed (S7: YES), the CPU 30a advances the process to step S9.

In step S9, the CPU 30a determines whether the change in the occurrence state of the event described above in step S7 indicates the occurrence of a new event. For example, if a new event occurs (S9: YES), the CPU 30a advances the process to step S11. If no new event has occurred, that is, if an event has been resolved (S9: NO), the CPU 30a advances the process to step S15 to be described below.

In step S11, the CPU 30a identifies a newly occurring event. The CPU 30a then advances the process to step S13 to make a notification about the newly occurring event.

In step S13, the CPU 30a executes the notification task in accordance with the above-described notification program 626. Although the notification task will be described below in detail, the execution of the notification task causes the dialog box 200 to be displayed, and thereby a notification is made. After executing the notification task in step S13, the CPU 30a advances the process to step S15.

In step S15, the CPU 30a executes the display update task in accordance with the above-described display update program 628. The display update task will be described below in detail. If the home menu 100 is displayed when the display update task is executed, the home menu 100 is redisplayed. In other words, the displayed content of the home menu 100 is updated. After executing the display update task in step S15, the CPU 30a advances the process to step S17.

In step S17, the CPU 30a updates the above-described temporary storage table described above, and specifically directly copies the content of the status management table 400 to the temporary storage table. With the execution of step S17, the CPU 30a ends the status management task.

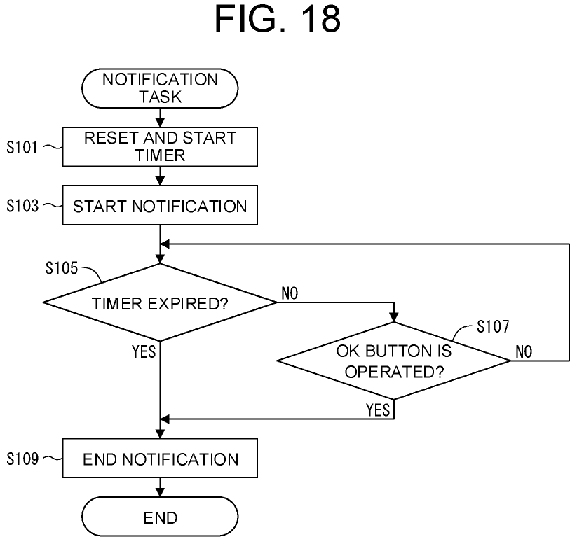

The notification task in step S13 described above will now be explained. FIG. 18 illustrates the process of the notification task.

In the notification task, the CPU 30a resets the timer for counting the above-mentioned predetermined time period in step S101, and then starts the timer. The timer is, for example, a software timer configured by the CPU 30a. Alternatively, the timer may be a hardware timer configured by a circuit separate from the CPU 30a. After executing step S101, the CPU 30a advances the process to step S103.

In step S103, the CPU 30a starts the notification about the newly occurring event. That is, the CPU 30a starts displaying, on the display 26b, the dialog box 200 including the character string 210 corresponding to the newly occurring event. The CPU 30a then advances the process to step 5105.

In step S105, the CPU 30a determines whether the timer for counting the above-mentioned predetermined time period has timed up, that is, whether the first period Ta has elapsed since the counting of the predetermined time period was started. For example, if the predetermined time period has elapsed (S105: YES), the CPU 30a advances the process to step S109. If the predetermined time period has not elapsed (S105: NO), the CPU 30a advances the process to step S107.

In step S107, the CPU 30a determines whether the OK button 220 of the dialog box 200 has been operated. For example, if the OK button 220 is operated, that is, if the OK button 220 is operated before the above-described predetermined time period has elapsed (S107: YES), the CPU 30a advances the process to step S109. If the OK button 220 is not operated (S107: NO), the CPU 30a returns the process to step S105.

In step S109, the CPU 30a ends the display of the dialog box 200, that is, ends the notification by the display of the dialog box 200. With step S109, the CPU 30a completes the notification task.

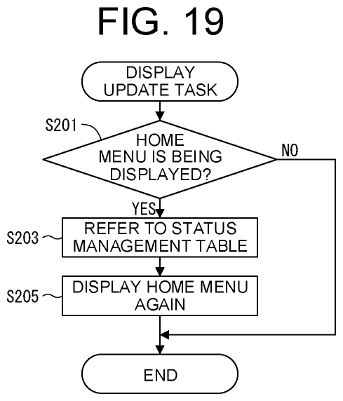

The display update task in step S15 described above will now be explained. FIG. 19 illustrates the process of the display update task.

In the display update task, the CPU 30a determines whether the home menu 100 is currently displayed in step S201. For example, if the home menu 100 is not displayed (S201: NO), the CPU 30a ends the display update task. If the home menu 100 is displayed (S201: YES), the CPU 30a advances the process to step S203.

In step 203, the CPU 30a refers to the status management table 400. The CPU 30a then advances the process to step S205.

In step S205, the CPU 30a redisplays the home menu 100 on the basis of the referred result of the status management table 400 in step S203. At this time, if an event is occurring, i.e., if there is an unresolved event, a badge corresponding to the event is displayed. With the execution of step S205, the CPU 30a ends the display update task.

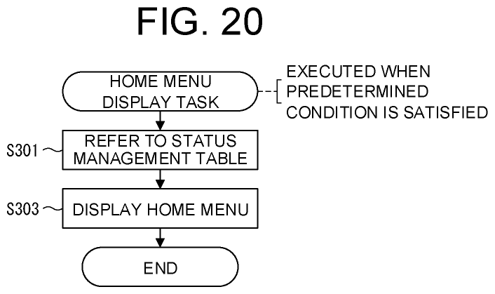

The CPU 30a executes the home-menu display task in accordance with the home-menu display program described above. FIG. 20 illustrates the process of the home-menu display task. Note that the home-menu display task is executed when predetermined conditions for displaying the home menu 100 are satisfied. The predetermined conditions include turning on the power of the multifunction peripheral 10, operating the home button 26d described above (home return operation), and operating the power-saving button 26c when the operation mode of the multifunction peripheral 10 is the power-saving mode (mode switching operation).

In the home-menu display task, the CPU 30a refers to the status management table 400 in step S301. The CPU 30a then advances the process to step S303.

In step S303, the CPU 30a displays the home menu 100 on the basis of the referred result of the status management table 400 in step S301. At this time, if an event is occurring, i.e., if there is an unresolved event, a badge corresponding to the event is displayed. With the execution of step S303, the CPU 30a ends the home-menu display task.

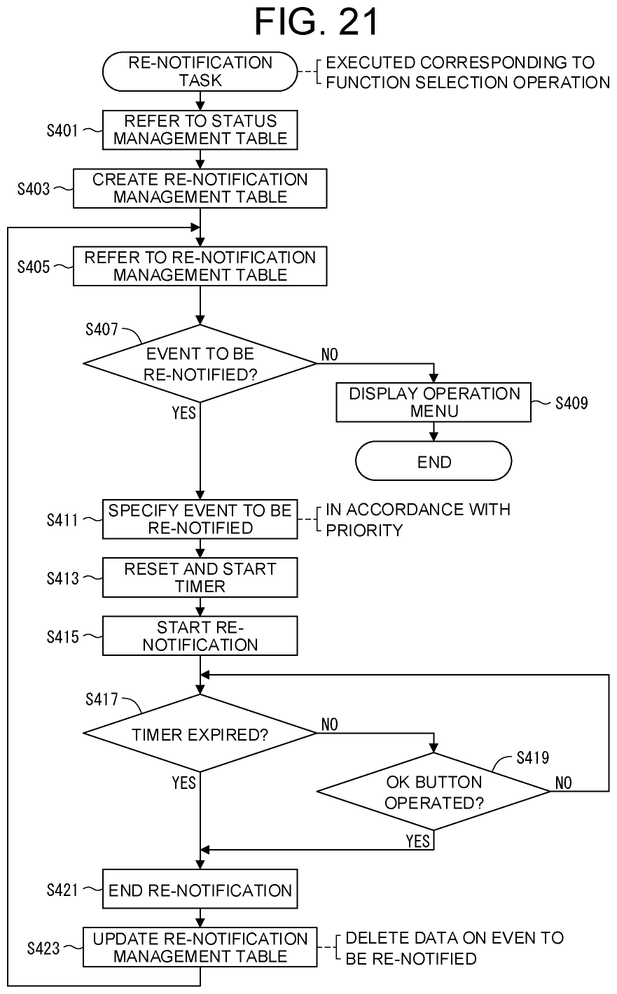

The CPU 30a further executes the re-notification task in accordance with the above-described re-notification program 632. FIG. 21 illustrates the process of the re-notification task. The re-notification task is performed in response to a function selection operation for selecting any function of the multifunction peripheral 10, including operating the above-described function selection mini-icons 122, 124, 126, and 128 and the function selection icons 142, 144, 146, and 148.

In the re-notification task, the CPU 30a refers to the status management table 400 in step S401. The CPU 30a then advances the process to step S403.

In step S403, the CPU 30a creates the re-notification management table 500 on the basis of the referred result of the status management table 400 in step S401. Specifically, the CPU 30a extracts, from the status management table 400, data on only the events that affect or might affect the function corresponding to the function selection operation serving as a trigger of the execution of the re-notification task. The CPU 30a then stores the extracted data in the re-notification management table 500. The data stored in the re-notification management table 500 is given an appropriate management number as described above. The CPU 30a then advances the process to step S405.

In step S405, the CPU 30a refers to the re-notification management table 500. The CPU 30a then advances the process to step S407.

In step S407, the CPU 30a determines whether there is an event that is a subject of re-notification on the basis of the referred result of the re-notification management table 500 in step S405, that is, whether any data is stored in the re-notification management table 500. For example, if there is no event that is a subject of re-notification, that is, if no data is stored in the re-notification management table 500 (S407: NO), the CPU 30a advances the process to step S409. If there is an event that is a subject of re-notification, that is, if data is stored in the re-notification management table 500 (S407: YES), the CPU 30a advances the process to step S411.

In step S409, the CPU 30a displays, on the display 26b, an operation menu corresponding to the function selection operation that triggered the execution of the re-notification task. With step S409, the CPU 30a completes the re-notification task.

When the process proceeds from step S407 to step S411, the CPU 30a identifies one of the events to be the subject of re-notification in step S411. In specific, the CPU 30a identifies the event having the highest priority described above among the data items stored in the re-notification management table 500, that is, among the events that are subject of re-notification. The CPU 30a then advances the process to step S413.

In step S413, the CPU 30a resets the timer for counting the above-mentioned predetermined time period, and then starts the timer. The CPU 30a then advances the process to step S415.

In step S415, the CPU 30a starts the re-notification of the event identified in step S411. That is, the CPU 30a starts displaying, on the display 26b, the dialog box 200 including the character string 210 corresponding to the event. The CPU 30a then advances the process to step S417.

In step S417, the CPU 30a determines whether the timer for counting the above-mentioned predetermined time period has timed up, that is, whether the first period Ta has elapsed since the counting of the predetermined time period was started. For example, if the predetermined time period has elapsed (S417: YES), the CPU 30a advances the process to step S421. If the predetermined time period has not elapsed (S417: NO), the CPU 30a advances the process to step S419.

In step S419, the CPU 30a determines whether the OK button 220 of the dialog box 200 has been operated. For example, if the OK button 220 is operated, that is, if the OK button 220 is operated before the above-described predetermined time period has elapsed (S419: YES), the CPU 30a advances the process to step S421. If the OK button 220 is not operated (S419: NO), the CPU 30a returns the process to step S417.

In step S419, the CPU 30a ends the display of the dialog box 200, that is, ends the re-notification by the display of the dialog box 200. The CPU 30a then advances the process to step S423.

In step S423, the CPU 30a updates the re-notification management table 500, that is, deletes data on the event for which re-notification has been performed from the re-notification management table 500. The CPU 30a then returns the process to step S405.

As described above, the multifunction peripheral 10 according to the first embodiment enables a user to intuitively recognize the occurrence of an event that affects or might affect at least one of the functions of the multifunction peripheral 10 and be informed about which function is affected or likely to be affected by the event. This is extremely beneficial in various aspects regarding the use and management of the multifunction peripheral 10.

Each function selection icon including each of the function selection icons 142, 144, 146 and 148 according to the first embodiment is an example of an operator according to the present invention. The operation of the function selection icon, that is, the function selection operation is an example of the selection operation according to the present invention.

The home menu 100 is displayed in accordance with the control by the CPU 30a. Such a CPU 30a is an example of the display controller according to the present invention. More specifically, the CPU 30a that executes the display update task illustrated in FIG. 19 and the home-menu display task illustrated in FIG. 20 is an example of the display controller according to the present invention.

When an event occurs, a dialog box 200 corresponding to the event is displayed. The dialog box 200 is an example of the first menu according to the present invention. In other words, the dialog box 200 is an example of first information according to the present invention. The dialog box 200 is displayed in accordance with the control by the CPU 30a. The CPU 30a, in cooperation with the display 26b, constitutes an example of a first information output device according to the present invention. More specifically, the CPU 30a that executes the notification task illustrated in FIG. 18, in cooperation with the display 26b, constitutes an example of the first information output device according to the present invention.

In the case where the multifunction peripheral 10 includes a voice output device, such as a speaker (not illustrated), a message of the same content as that of the character string 210 included in the dialog box 200 may be output from the voice output device as voice. That is, in addition to or in place of the visual notification of the display of the dialog box 200, an auditory notification may be output as a voice message.

In the first embodiment, notification is made only for a newly occurring event. The notification, however, is not limited thereto. For example, notifications for all unresolved events at that time may be made sequentially, including events that are occurring when a new event occurs. The order of the notifications should follow the priorities described above.

In the first embodiment, when the function indicated by a badge display is selected by a function selection operation, the dialog box 200 is redisplayed, that is, re-notification is performed. The displayed dialog box 200 displayed for the re-notification is an example of a second menu according to the present invention. In other words, the dialog box 200 is an example of second information according to the present invention. The dialog box 200 for the re-notification is displayed in accordance with the control by the CPU 30a. The CPU 30a, in cooperation with the display 26b, constitutes an example of a second information output device according to the present invention. More specifically, the CPU 30a that executes the notification task illustrated in FIG. 21, in cooperation with the display 26b, constitutes an example of the second information output device according to the present invention.

For the re-notification, in addition to or in place of the visual notification of the display of the dialog box 200, an auditory notification may be output as a voice message.

In the first embodiment, re-notification is made only for an event regarding the selected function. The notification, however, is not limited thereto. For example, re-notification for all unresolved events at that time may be performed sequentially. It is desirable that the order of the notifications follow the priorities described above.

The function selection operation that triggers the re-notification is an example of an information output operation according to the present invention. The function selection operation is received through any of the function selection icons including the function selection icons 142, 144, 146 and 148, or any of the function selection mini-icons 122, 124, 126 and 128. The software keys that receives the function selection operation are examples of an operation receiver according to the present invention. The operation receiver may be a dedicated software key or hardware key may.

In the first embodiment, the dialog box 200 is a modal dialog including the OK button 220. However, the dialog box 200 is not limited thereto. In other words, the dialog box 200 may be a modeless (non-modal) dialog that does not include the OK button 220. In such a case, it is desirable to configure the modeless dialog to disappear when a predetermined operation is performed or when the above-mentioned predetermined time period has elapsed.

In the first embodiment, a badge display is appropriately provided for each function selection icon including each of the function selection icons 142, 144, 146 and 148. The badge display is not limited thereto. For example, in addition to or in place of the badge display for each function selection icon, a badge display may be made for each of the function selection mini-icons 122, 124, 126 and 128.

### Second Embodiment

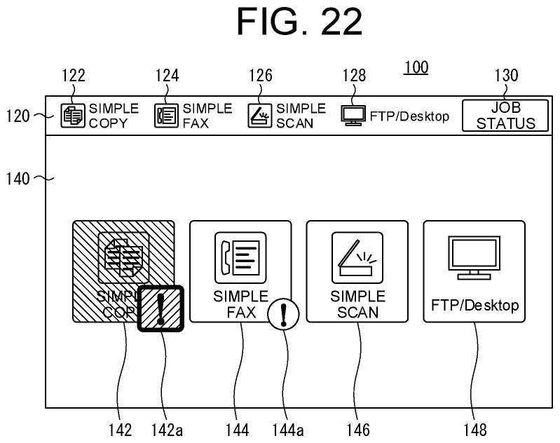

A second embodiment of the present invention will now be described with reference to FIG. 22.

In the second embodiment, the home menu 100 displayed, for example, when the “black toner empty” event occurs has the configuration illustrated in FIG. 22. The “black toner empty” event affects the copy function. The copy function selection icon 142 for selecting the copy function is grayed out, that is, the copy function selection icon 142 is displayed differently from the other function selection icons 144, 146, and 148 illustrated in FIG. 22. The gray-out disables the reception of operation by the copy function selection icon 142.

In FIG. 22, the copy function selection icon 142 is hatched to indicate that the display of the copy function selection icon 142 is grayed out. The state illustrated in FIG. 22 corresponds to, for example, the state illustrated in FIG. 7 according to the first embodiment. In the state illustrated in FIG. 22, the reception of the operation of the copy function selection mini-icon 122 is also disabled. In such a case, the copy function selection mini-icon 122 may also be grayed out, although it is not illustrated.

In the state illustrated in FIG. 22, the reception of an operation by each of the copy function selection icon 142 and the copy function selection mini-icon 122 is disabled, as described above. When the badge 142a attached to the copy function selection icon 142 is operated, the dialog box 200 illustrated in FIG. 6 is displayed on the display 26b. In other words, the badge 142a indicating that an event that affects with the copy function is occurring serves as an operation key for displaying the dialog box 200. Therefore, a user can confirm that the event represented by the badge 142a is the “black toner empty” event on the basis of the content of the dialog box 200 (character string 210) displayed in response to the operation of the badge 142a. When a predetermined time period elapses after the OK button 220 of the dialog box 200 has been operated or the dialog box 200 has been displayed, the dialog box 200 disappears. The state returns to that illustrated in FIG. 22, that is, the home menu 100 is displayed in place of the operation menu for the copy function. In specific, when an event that affects the copy function is occurring, the operation menu for the copy function is not displayed. Therefore, the copy function cannot be used.

When, for example, the facsimile function selection icon 144 with the badge 144a in the state illustrated in FIG. 22, is operated, the dialog box 200 illustrated in FIG. 6 is displayed on the display 26b. This is when the facsimile function selection mini-icon 124 is operated in the state illustrated in FIG. 22. When also the badge 144a attached to the facsimile function selection icon 144 is operated, the dialog box 200 illustrated in FIG. 6 may be displayed on the display 26b. In other words, the badge 144a may also function as an operation key for displaying the dialog box 200. When a predetermined time period elapses after the OK button 220 of the dialog box 200 has been operated or the dialog box 200 has been displayed, the dialog box 200 disappears. Subsequently, the operation menu for the facsimile function is displayed on the display 26b in place of the home menu 100. Note that even if the operation menu for the facsimile function is displayed, only the facsimile transmission function can be used. In other words, the facsimile function can be used with restrictions.

When an event that affects any function other than the copy function occurs, the function selection icon for selecting that function is grayed out, and thereby the reception of the operation of the function selection icon is disabled. The reception of the operation of the corresponding function selection mini-icon is also disabled. In such a case as well, the function selection mini-icon may be grayed out. A badge is attached to the grayed-out function selection icon. This badge has the same configuration as the badge 142a illustrated in FIG. 22 that makes the badge stand out. When the icon attached to the greyed-out function selection icon is operated, a dialog box indicating the content of the event represented by the icon is displayed on the display 26b. In other words, the badge attached to the greyed-out function selection icon serves as an operation key for displaying a dialog box indicating the content of the event represented by the badge. The dialog box also includes an OK button like the dialog box 200 described above. When the OK button is operated, or when a certain time elapses after the dialog box has been displayed, the dialog box disappears. Subsequently, the state returns to the state before the dialog box is displayed, that is, the home menu is displayed again.

According to the second embodiment, a user can intuitively determine a function that is affected by the occurrence of an event, that is, a function disabled. This is also extremely beneficial in various aspects regarding the use and management of the multifunction peripheral 10.

Although detailed descriptions including illustrations are omitted, the gray-out in the second embodiment is performed by the CPU 30a. Such a CPU 30a is an example of a disabling device according to the present invention. Besides gray-out, appropriate colors and patterns may be provided.

### Third Embodiment

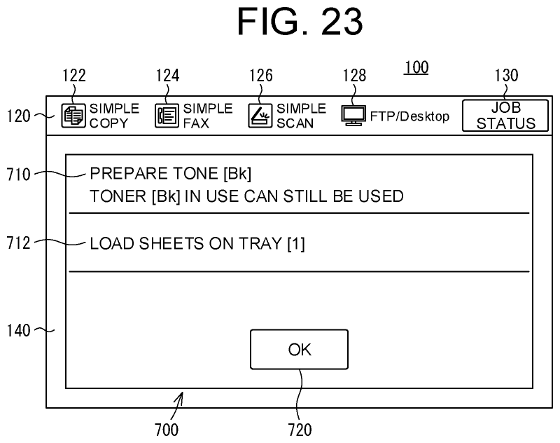

A third embodiment of the present invention will now be described with reference to FIG. 23.

In the third embodiment, a dialog box 700, such as that illustrated FIG. 23, is displayed on the display 26b as a notification or re-notification of a plurality of events occurring. The dialog box 700 includes character strings 710 and 712 representing a plurality of messages corresponding to a plurality of unresolved events that are occurring. In an example, the dialog box 700 includes two messages corresponding to two unresolved events. In the example, two events are occurring: a “black-toner level low” event and a “tray [1] empty” event. The user receives a notification or a re-notification through the display of the dialog box 700 including the character strings 710 and 712. This enables the user to recognize at once that two events corresponding to the character strings 710 and 712 are occurring. In other words, the user can collectively recognize that a plurality of events are occurring.

Note that the dialog box 700 in the third embodiment is also a modal dialog including an OK button 720. When the OK button 720 is operated, the dialog box 700 disappears. When a predetermined time period elapses after the dialog box 700 has been displayed, the dialog box 700 disappears. Although detailed descriptions including illustrations are omitted, in the case of the occurrence of a plurality of events, the dialog box 700 including character strings representing a plurality of messages corresponding to the events is displayed.

According to the third embodiment, the user can recognize the content of the events at once particularly when a plurality of events are occurring. This is also extremely beneficial in various aspects regarding the use and management of the multifunction peripheral 10.

Also, in the third embodiment, a modeless dialog may be employed besides the dialog box 700 which is a modal dialog. In such a case, it is desirable to configure the modeless dialog to disappear when a predetermined operation is performed or when the above-mentioned predetermined time period has elapsed.

### Other Application Examples

The above-described embodiments are specific examples of the present invention and do not limit the technical scope of the present invention. The present invention can also be applied to aspects other than these examples.

For example, the electrophotographic image former 18 is employed as an image former. Alternatively, an inkjet type image former may be employed. In such a case, a “low ink level” event is provided in place of the “black-toner level low” event and the “color-toner level low” event. Furthermore, a “out of ink” event is provided in place of the “out of black toner” event and the “out of color toner” event.

In each embodiment, an example in which the present invention is applied to the multifunction peripheral 10 has been described. However, the present invention is not limited thereto. The present invention can be applied to image forming apparatuses other than the multifunction peripheral 10. The present invention can be applied to electric apparatuses other than the multifunction peripheral 10. An example of an electric apparatus to which the present invention can be applied is a humidifying and air-purifying heater.

In other words, the humidifying and air-purifying heater has a plurality of functions including a humidifier function, an air purifier function, and a heater or blower function. In such the humidifying and air-purifying heater, for example, even if the humidifying water runs out, it can be used as an air cleaner or a heater. Furthermore, even if the filter for air purification becomes dirty, the humidifying and air-purifying heater can be used as a humidifier or a heater. The present invention can also be applied to such a humidifying and air-purifying heater.

In an extreme case, the present invention can be applied to an electric apparatus having an external display.

### DESCRIPTION OF REFERENCE NUMERALS

10 multifunction peripheral

26 operating device

26a touch panel

26b display

30 controller

30a central processing unit (CPU)

100 home menu

142, 144, 146, 148 function selection icon

142a, 142b, 144a, 144b, 146a, 148a badge

200 dialog box

What is claimed is:

1. An electric apparatus having a plurality of functions, comprising:
a display controller that displays, on a display screen of a display, an operation menu including a plurality of operators, the plurality of operators corresponding respectively to the plurality of functions, the plurality of operators capable of receiving a selection operation by a user selecting any of the plurality of functions,
wherein, when an event that affects or might affect at least one of the plurality of functions occurs, the display controller attaches an indicator indicating the occurrence of the event to the plurality of operators corresponding respectively to the plurality of functions that are affected or might be affected by the event.

2. The electric apparatus according to claim 1, wherein the display controller attaches the indicator in a mode corresponding to a relationship between the plurality of functions corresponding to the plurality of operators to which the indicator is attached and the event represented by the indicator.

3. The electric apparatus according to claim 1, wherein, when a plurality of the events occur, the display controller attaches the indicator to each of the plurality of events.

4. The electric apparatus according to claim 1, further comprising:
a first information output device that outputs first information regarding to the event when the event occurs.

5. The electric apparatus according to claim 4, wherein the first information output device displays a first menu including the first information on the display screen.

6. The electric apparatus according to claim 1, further comprising:
an operation receiver that is able to receive an information output operation by the user; and
a second information output device that outputs second information regarding the event unresolved when the information output operation is received by the operation receiver.

7. The electric apparatus according to claim 6, wherein the second information output device displays a second menu including the second information on the display screen.

8. The electric apparatus according to claim 7,
wherein, when a plurality of the events are unresolved when the information output operation is received by the operation receiver, the second information output device displays the second menu including the second information regarding the plurality of events.

9. The electric apparatus according to claim 1, further comprising:
a disabling device that disables receiving of the selection operation on the plurality of operators corresponding to the plurality of functions that are affected by the event.

10. The electric apparatus according to claim 9, wherein the display controller displays the plurality of operators disabled from receiving the selection operation by the disabling device, the plurality of operators being displayed in a mode different from the other operators.

11. The electric apparatus according to claim 1, wherein the electric apparatus comprises the display.

12. The electric apparatus according to claim 1, wherein the electric apparatus comprises a multifunction peripheral.

13. A non-transitory computer-readable recording medium that stores therein a status management program for an electric apparatus having a plurality of functions, the program causing a computer of the electric apparatus to execute a display control procedure comprising:
displaying, on a display screen of a display, an operation menu including a plurality of operators, the plurality of operators corresponding respectively to the plurality of functions, the plurality of operators capable of receiving a selection operation by a user selecting any of the plurality of functions; and
attaching an indicator to the plurality of operators corresponding respectively to the plurality of functions that are affected or might be affected by an event, the indicator indicating the occurrence of the event, the indicator being attached when the event that affects or might affect at least one of the plurality of functions occurs.

14. A method of managing a status of an electric apparatus having a plurality of functions, the method comprising:
controlling to display, on a display screen of a display, an operation menu including a plurality of operators, the plurality of operators corresponding respectively to the plurality of functions, the plurality of operators capable of receiving a selection operation by a user selecting any of the plurality of functions; and
attaching in the controlling an indicator to the plurality of operator corresponding respectively to the plurality of functions that are affected or might be affected by an event, the indicator indicating the occurrence of the event, the indicator being attached when the event that affects or might affect at least one of the plurality of functions occurs.
